(19) United States
(12) Patent Application Publication
(10) Pub. No.: US 2011/0259089 A1
(43) Pub. Date: Oct. 27, 2011

(54) Devices Having An Inert Surface And Methods Of Making Same

(75) Inventors: Edouard S. P. Bouvier, Stow, MA (US); Moon Chul Jung, Cambridge, MA (US)

(73) Assignee: WATERS TECHNOLOGIES CORPORATION, Milford, MA (US)

(21) Appl. No.: 13/054,195

(22) PCT Filed: Jul. 16, 2009
(86) PCT No.: PCT/US09/50845

§ 371 Date: Feb. 22, 2011

Related U.S. Application Data
(60) Provisional application No. 61/081,848, filed on Jul. 18, 2008.

(51) Int. Cl. G01N 30/02

(52) U.S. Cl. 73/61.52

(57) ABSTRACT

The present invention features devices and methods of making such devices for performing liquid chromatography having at least one wetted surface having a composition of a polysilazane.

### CROSS REFERENCE RELATED APPLICATION

This application claims priority from U.S. Provisional Patent Application No. 61/081,848, filed Jul. 18, 2008. The contents of these applications are incorporated herein by reference.

### FEDERAL SPONSORSHIP

This invention was not developed with Federal sponsorship.

### FIELD OF INVENTION

This invention relates to apparatus having a surface comprising one or more coatings that are relatively inert and methods for making such surfaces.

### BACKGROUND OF THE INVENTION

Materials used to make fluid conduits, flow cells, pumps, valves, separation devices and the like in apparatus used for diagnostic and analytical are preferably inert. As used herein, the term inert means that the material in contact with the fluid carrying analytes does not add compounds to the fluid, does not absorb or adsorb compounds from the solution, and does not react with the compounds in the solution. Unfortunately, several of the base materials which are used to transport or contain or power fluids through these devices are not sufficiently inert. This problem becomes more acute as the scale of the conduits and subparts of the device are reduced in scale. The small scale of microfluidic devices has forced the use of materials as a base substrate that have desirable features from a manufacturing view but are less than ideal for fluid conveyance.

As used herein, the term “microfluidic” refers to channels, conduits, capillaries, tubings, pipes and the like of approximately 1-500 micrometer in diameter. As used herein, the term “analyte” refers to one or more compounds that it is desirable to detect or quantify. The term “solute” is used in a broad sense to denote a material in which a material is dissolved.

Chromatography is a technology by which compounds in solution are separated. The compounds are separated by the unique affinity of a compound to a material that is in contact with the solute. Liquid chromatography uses liquid as a mobile phase. A stationary phase, such as a solid support, is used to adsorb the analyte. Chromatography methods often use dilute acidic and basic aqueous solutions, and water miscible solvents, such as acetonitrile and methanol. These solutions are often deleterious to the materials, which conduits, channels, tubings, pipes, solid support or components of the apparatus on which the chromatography is performed, are made of. Or, the materials, which conduits, channels, tubings, pipes or components of the apparatus on which the chromatography is performed, leach or absorb compounds into or from the solute.

There is a need for a coating technology to reproducibly and cost-effectively create a diffusion barrier within a microfluidic channel.

### SUMMARY OF THE INVENTION

Embodiments of the present invention feature liquid chromatography devices having at least one wetted surface comprising a polysilazane or a polysilazane-like material. Such liquid chromatography device comprises components, channel devices, conduits, flow cells, valves, pumps, supports, columns, and column fittings and frits made of or coated with a polysilazane and polysilazane-like materials. As used herein, the term silazane refers to a hydride of silicon and nitrogen. A preferred polysilazane or polysilazane-like material has the formula set forth below:

-[A]ₓ-[B]_{y}- Formula 1.

As used above, A represents

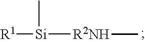

wherein R¹ and R² each independently represent hydrogen, alkyl, alkenyl, alkynyl, aromatic, amino alkyl, amino alkenyl, amino alkynyl, pyridinyl, pyrridonyl, and carbonyl, alcohol and carboxylic acid derivatives thereof having one to twenty five atoms, and hydroxyl, amino, amide, carboxyl, ester, carbonyl, sulfhydryl, sulfonyl, phosphoral, bromo, iodo, chloro and fluoro derivatives; the silane is covalently linked to the nitrogen and the vacant valence of the silane is to a further A or B or terminal hydrogen or hydroxyl group or alkyl, alkene or alkyne or trace co-reactants;

As used above, B represents

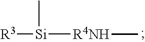

wherein R³ and R⁴ each independently represent hydrogen, alkyl, alkenyl, alkynyl, aromatic, amino alkyl, amino alkenyl, amino alkynyl, pyridinyl, pyrridonyl, and carbonyl, alcohol and carboxylic acid derivatives thereof having one to twenty five atoms, and hydroxyl, amino, amide, carboxyl, ester, carbonyl, sulfhydryl, sulfonyl, phosphoral, bromo, iodo, chloro and fluoro derivatives; the silane is covalently linked to the nitrogen and the vacant valence of the silane is to a further A or B or terminal hydrogen or hydroxyl group or alkyl, alkene, alkyne, or W or trace co-reactants. As used above, W is represented by the formula —R⁶—Si—R⁸ₐ⁻R⁷_{b}. R⁶ is as defined with respect to R¹ or R². R⁷ is hydrogen or C₁-C₆ straight, cyclic or branched alkyl group. R⁸ is Cl, Br, I, C₁-C₅ alkoxy, dialkylamino or trifluoromethanesulfonate; a and b are each an integer from 0 to 3 provided that a+b=3.

A preferred alkoxy group for R⁸ is methoxy and a preferred alkyl for R⁷ is methyl. And, X and Y represent relative amounts of A or B as decimals that together add to 1.0.

As used herein, the term “independently represent” means that the chemical groups may be the same or different. And, to the extent the formula above may deviate from established silazane chemistry definitions, the formulas are controlling. This paper uses the term “polysilazane” to denote materials conforming to Formula 1 and such materials which after curing to form ceramic type materials may not hold true to the formulas of the starting materials, due to polymerization, thermal decomposition or rearrangement.

Preferrably, at least one of R¹ and R² is alkyl and at least one is alkenyl. And, preferrably, at least one of R³ and R⁴ is alkyl and at least one is hydrogen.

A preferred silazane is represented by the polysilazane formula set forth below:

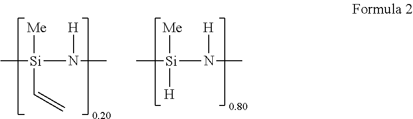

As used herein, the term “wetted surface” refers to a surface of a solid material exposed or in contact with aqueous or organic solutions.

Coatings, devices, components and apparatus made from compositions corresponding to Formula 1 are inert to typical chromatographic mobile phases, such as dilute acidic and basic aqueous solutions, and water miscible solvents, such as acetonitrile and methanol or have groups R¹, R², R³ and R⁴ selected for such inertness. Preferred materials and R¹, R², R³ and R⁴ groups, and coatings, devices, components and apparatus made thereof have non-porous wetted surfaces with low binding/low adsorption towards acidic, basic or hydrophobic analytes. Preferred materials and R¹, R², R³ and R⁴ groups, and coatings, devices, components and apparatus made thereof do not crack or shrink upon curing. Preferred materials and R¹, R², R³ and R⁴ groups, and coatings, devices, components and apparatus made thereof do not shrink or swell in typical chromatographic solvents. With respect to coatings of silazane based materials, the coatings have a thermal expansion coefficient similar to that of the bulk material that is being coated. Coatings, devices, components and apparatus are suitable for use at typical HPLC/HPLC operating temperatures and pressures of 15,000 psi.

These and other advantages and features will be apparent to those skilled in the art upon reading the detailed description and viewing the drawings that follow.

### BRIEF DESCRIPTION OF THE DRAWINGS

FIG. 1 depicts a column in partial cross section having a frit embodying features of the present invention;

FIG. 2 depicts a frit having features of the present invention;

FIG. 3 depicts a microfluidic device having features of the present invention; and,

FIG. 4 depicts a microfluidic device having features of the present invention.

### DETAILED DESCRIPTION OF THE INVENTION

Embodiments of the present invention in detail as liquid chromatography devices having at least one wetted surface comprising a polysilazane or a polysilazane-like material. Those skilled in the art will recognise that embodiments of the present invention have utility and applications in other devices for which leaching of materials from the structures containing or transporting fluids is a potential problem.

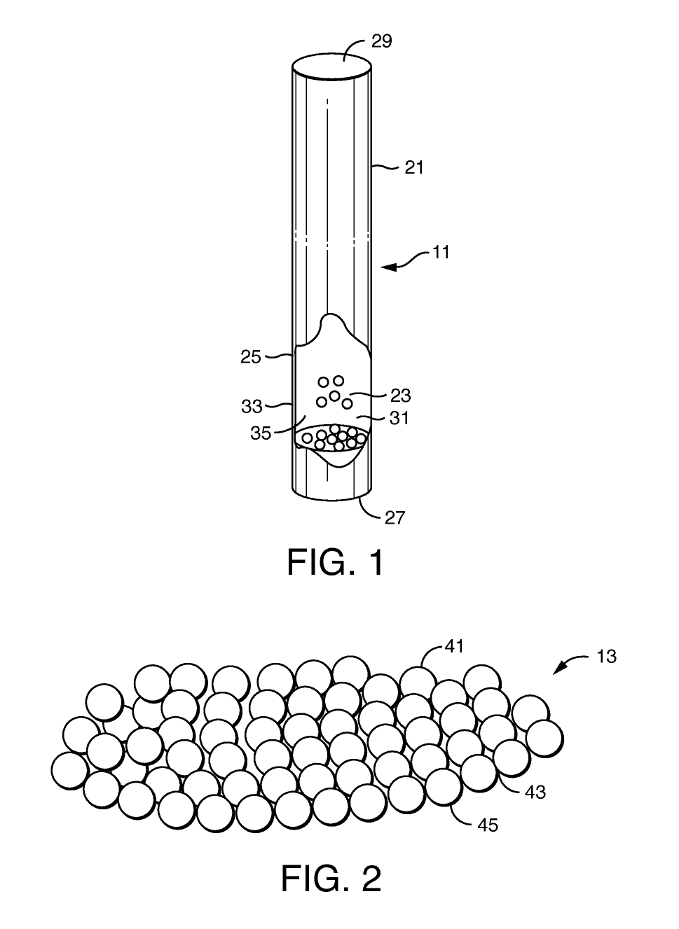

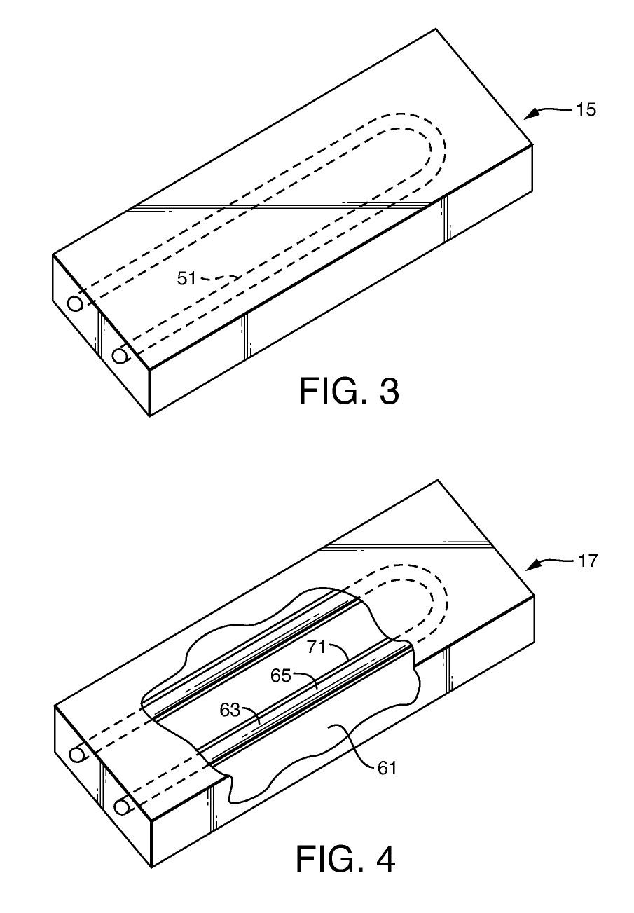

FIGS. 1-4 depict liquid chromatography devices or components thereof having features of the present invention. These figures depict a column, shown in FIG. 1, generally designated by the numeral 11; a frit, shown in FIG. 2, generally designated by the numeral 13; and microfluidic devices, generally designated by the numerals 15 and 17, depicted in FIGS. 3 and 4.

Turning first to FIG. 1, the column 11 in simplified form in partial cut-away. The column, as depicted has a housing 21, media 23, and a frit 13. Housing 21 is a cylindrical tube formed of at least one wall 25 and having a first end 27, a second end 29. Housing 21 may comprise cross-sectional shapes other than a circle, for example, rectangles, octagonal, and the like; however, such shapes are less conventional. The wall 25 has an interior surface 31 and an exterior surface 33.

The interior surface 31 of wall 25 defines a chamber 35 for containing the media 23. The media 23 is a packed bed of particles, fibers, or a monolith structure.

The first end 27 and second end 29 are generally similar in features. This paper will describe only the first end 27 as such details relate to the invention. The column 11 would normally comprise fittings for attachment to other conduits which have been omitted from the drawings for simplification.

At least one of the housing 21, frit 13, media 23 or other components of the column or chromatography systems in general [not shown] are made of or have a coating of a polysilazane or polysilazane-like material. For example, without limitation, pump components and valves may be made of or be coated with a polysilazane or polysilazane-like material.

FIG. 2 depicts frit 13 made with a polysilazane or polysilazane-like material. The frit 13 is a plug 41 of particles having interstitial spaces 43 through which fluids flow. Turning now to FIGS. 1 and 2, the interstitial spaces 43 extend through the plug 41 to allow the flow of fluid through the frit 13 while substantially retaining the media 23 which is contained in the chamber 35.

As depicted in in FIG. 2, the particles have a underlying substrate 45, for example, without limitation, silica, or metal oxides. The particles bear a coating of a polysilazane or polysilazane-like material. This coating forms about the particles to form a plug of co-adhering particles. Those skilled in the art will readily appreciate that the particles described can be readily substituted with other forms such as fibers and the like.

Turning now to FIG. 3, a microfluidic device 15 is depicted having a channel 51 for conveying fluids in a chromatography instrument [not shown]. The channel 51 may further comprise detection sections [not shown], separation sections for performing chromatography [not shown], pumps [not shown], valves [not shown], connection sections [not shown] or any other component used in diagnostic or analytical equipment.

The microfluidic device 15 is comprised of, as in made from, a polysilazane material. The material obviates problems associated with microfluidic devices made of materials which are not entirely inert.

In the alternative, turning now to FIG. 4, a microfluidic device 17 of similar design as the microfluidic device 15 of FIG. 3, is depicted. The microfluidic device 17 has a device substrate 61. However, some ceramic compositions are not stable at all hydrogen ion concentrations and solvents. For example, some Low Temperature Co-fired Ceramic (LTCC) materials, such as Dupont 951, are not fully inert. Dupont 951 has a composition of: 48 wt % Al₂O₃, 31% SiO₂, 0.03% TiO₂, 1.99% B₂O₃, 0.03% BaO, 4.48% CaO, 0.86% K₂O, 11.3% PbO. This material has excellent mechanical strength, and it is relatively easy to manufacture reproducibly. However, the material can adsorb various analytes and affect the chromatographic separation. Acidic mobile phases that are commonly employed in liquid chromatography are known to solubilize some of the heavy metals from the LTCC materials.

A preferred substrate 61 is a ceramic such as LTCC materials.

The microfluidic device 17 is depicted having a channel 63 for conveying fluids in a chromatography instrument [not shown]. The channel 63 may further comprise detection sections [not shown], separation sections for performing chromatography [not shown], pumps [not shown], valves [not shown], connection sections [not shown] or any other component used in diagnostic or analytical equipment.

The microfluidic device 17 has a layer 65 comprised of a polysilazane or a polysilazane-like material. Preferably, the layer 65 is a cured polysilazane material. The layer 65 has at least one wetted surface 71 which is in direct contact with the fluids which flow through the device 17 by channel 63. The layer 65 seals the substrate 61 of microfluidic device 17 preventing the adsorption or absorption of analytes and preventing the leaching of metals into solutions flowing through channel 63.

A silazane refers to a hydride of silicon and nitrogen. Thus, a polysilazane is a polymer of such a hydride of silicon and nitrogen. A preferred polysilazane has the formula of Formula 1 set forth below:

-[A]ₓ-[B]_{y}- Formula 1

As used above, A represents

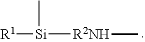

Wherein R¹ and R² independently represents alkyl, alkenyl, alkynyl, aromatic, amino alkyl, amino alkenyl, amino alkynyl, pyridinyl, pyrridonyl, and carbonyl, alcohol and carboxylic acid derivatives thereof having one to twenty five atoms, and hydroxyl, amino, amide, carboxyl, ester, carbonyl, sulfhydryl, sulfonyl, phosphoral, bromo, iodo, chloro and fluoro derivatives; the silane is covalently linked to the nitrogen and the vacant valence of the silane is to a further A or B or terminal hydrogen or hydroxyl group or alkyl, or trace co-reactants.

As used above, B represents

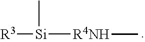

Wherein R³ and R⁴ independently represents hydrogen, alkyl, alkenyl, alkynyl, aromatic, amino alkyl, amino alkenyl, amino alkynyl, pyridinyl, pyrridonyl, and carbonyl, alcohol and carboxylic acid derivatives thereof having one to twenty five atoms, and hydroxyl, amino, amide, carboxyl, ester, carbonyl, sulfhydryl, sulfonyl, phosphoral, bromo, iodo, chloro and fluoro derivatives; the silane is covalently linked to the nitrogen and the vacant valence of the silane is to a further A or B or terminal hydrogen or hydroxyl group or alkyl, alkene or alkyne or trace co-reactants. As used above, W is represented by the formula —R⁶—Si—R⁸ₐ⁻R⁷_{b}. R⁶ is as defined with respect to R¹ or R². R⁷ is hydrogen or C₁-C₆ straight, cyclic or branched alkyl group. R⁸ is Cl, Br, I, C₁-C₅ alkoxy, dialkylamino or trifluoromethanesulfonate; a and b are each an integer from 0 to 3 provided that a+b=3. A preferred alkoxy group for R⁸ is methoxy and a preferred alkyl for R⁷ is methyl. And, X and Y represent relative amounts of A or B as decimals that together add to 1.0.

A preferred silazane is represented by the polysilazane formula set forth below:

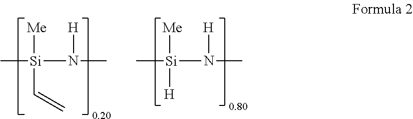

U.S. Pat. Nos. 6,329,487 and 6,652,978 both granted to Kion Corporation, disclose polysilazanes corresponding to Formula 1. These materials are sold under the trademark Kion Ceraset® Polysilazane 20 and G Shield™. Ceraset® Polysilazane 20 is described as a low viscosity liquid polymer that cures by heating to 180-2000, or at lower temperatures by addition of a free radical initiator. G Shield™ is described as a solution of liquid polysilazane polymer curable by moisture at a relatively low temperature.

Coatings, devices, components and apparatus made materials conforming generally to Formula 1 have R¹, R², R³ and R⁴ groups selected to be substantially inert. For example, materials conforming generally to Formula 2, such as cured ceramics formed of such materials, are inert to typical chromatographic mobile phases, such as dilute acidic and basic aqueous solutions, and water miscible solvents, such as acetonitrile and methanol. Coatings, devices, components and apparatus made materials conforming generally to Formula 1 have R¹, R², R³ and R⁴ groups selected to exhibit non-porous wetted surfaces with low binding/low adsorption towards acidic, basic or hydrophobic analytes. Coatings, devices, components and apparatus made materials conforming generally to Formula 1 have R¹, R², R³ and R⁴ groups selected to exhibit resistance to cracking or shrinking upon curing. For example, without limitation, materials formed with Formula 2 do not shrink or swell in typical chromatographic solvents. With respect to coatings of silazane based materials, the coatings preferrably have a thermal expansion coefficient similar to that of the bulk material that is being coated. Coatings, devices, components and apparatus are suitable for use at typical HPLC/HPLC operating temperatures and pressures of 15,000 psi.

Polysilazanes undergo thermal polymerization in three distinct phases. At temperatures up to 400 C, curing occurs, which is cross-linking primarily via bond rearrangement. Little change in density occurs during this stage. Between 400-800 C, mineralization occurs, in which hydrocarbons and hydrogen gas are evolved, mainly due to the breaking of Si—C and N—C bonds. The final stage, crystallization, occurs at temperatures above 800 C. In this stage, the primary change is the decrease in the H/Si ratio due to evolution of hydrogen gas. The latter two stages are accompanied by densification.

The method of making the devices of the present invention is exemplified in the following Examples.

### Example #1

### Channel Coating

This example describes the making of a microfluidic device 17, depicted in FIG. 4 having a channel 63. The device has a LTCC substrate 61. The channel 63 will be coated with a layer 65 of a polysilazane to create a wetted surface 71.

Channel 63 is coated filling the channel with liquid silazane hydrostatically, either by vacuum or pressure, followed by air or appropriate immiscible liquid. If a thinner film is desired, the solution can be first diluted with an appropriate solvent. Addition of a peroxide such as an organic peroxide can be used to reduce the curing temperature. Solvent can be driven off by initially heating to a temperature below the cure temperature. Curing can be achieved by increasing the temperature further to temperatures up to ˜200 C. An inert atmosphere may be preferred. In some instances, greater mechanical strength of the coating may be required. This can be achieved by addition of a filler material such as particles or fibers. The filler material may contain reactive groups on the surface that can polymerize with the pre-ceramic. Fillers may also be utilized to improve adhesion properties if the thermal expansion coefficient of the polysilazane differs substantially different from the LTCC material.

The channel 63 having a layer 65 would be utilized as conduits or as regions where chromatographic sorbents would be filled and used as either trap columns or analytical columns. Or, in the alternative, the layer 65 would be placed on microfluidic sections used in detection, valve or fluid control, connections, and other components.

### Example #2

### Chromatographic Frit Fabrication

This example describes the fabrication of a frit by bonding particles held in a column or device. A channel of a microfluidic device is abutted to a porous frit, then packed with chromatographic particles hydrostatically using a slurry of packing media. Subsequently, the chip is disconnected from the frit, and a small amount of a polysilazane monomer solution is applied to the packed bed, in the manner of sodium silicate or PDMS solution and then cured.

Use of a polysilazane dissolved in a solvent and curing is more reproducible to form a frit fabrication process. If an appropriately low boiling point solvent is used, then as the solvent evaporates, it will prevent the silazane from polymerizing within the interstitial channels of the packed bed. This will thus prevent blockage of the microfluidic channel, and enable high bed permeabilities and more reproducible fabrication.

### Example 3

### Microfluidic Device Fabrication

A microfluidic device such as a chip is made by creating a mold of the device and filling the mold with a monomer solution of silazanes and curing the silazane monomers to form a polysilazane substrate. A peroxide such as an organic peroxide can be used to reduce the curing temperature. Solvent can be driven off by initially heating to a temperature below the cure temperature. Curing can be achieved by increasing the temperature further to temperatures up to ˜200 C. In some instances, greater mechanical strength of the coating may be required. This can be achieved by addition of a filler material such as particles or fibers. The filler material may contain reactive groups on the surface that can polymerize with the pre-ceramic.

The chips can be injection molded to the cured state. In this state, the pre-ceramic chips can be machined, laser cut, etc. Any electrical connections can be added to the pre-ceramic state chip. Two separate halves of the chip may be fabricated. The halves are then require aligned, and fired under pressure to fuse the halves together. A solution of liquid silazane may be utilized to improve bond strength. Microfluidic channel integrity may need to be maintained by addition of a sacrificial material that can be subsequently removed via solvent, heat, or other means. Bringing the material to the ceramic state (heating above 1200 C) may be useful to further increase bond strength. Fillers may be used in the chip fabrication to further enhance mechanical strength. Alternatively, the ceramic may be housed within a hardened shell for further improvement in mechanical strength.

Thus, preferred embodiments of the present invention have been described with the understanding that such embodiments are subject to modification and alteration. Therefore, the present invention should not be limited to the precise details but should encompass the subject matter of the claims that follow and their equivalents.

We claim:

1. A device for performing liquid chromatography having at least one wetted surface having a composition of a polysilazane or polysilazane-like material.

2. The device of claim 1 wherein said wetted surface is part of at least one of the group selected from components, channel devices, conduits, flow cells, valves, pumps, supports, columns, microfluidic devices and column fittings and frits.

3. The device of claim 1 wherein says wetted surface is a layer of said composition.

4. The device of claim 1 wherein said device is made of said composition.

5. The device of claim 1 wherein said polysilazane or polysilazane-like material has the formula set forth below:
-[A]ₓ-[B]_{y}- Formula 1;
as used above, A represents 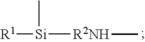
wherein R¹ and R² each independently represent hydrogen, alkyl, alkenyl, alkynyl, aromatic, amino alkyl, amino alkenyl, amino alkynyl, pyridinyl, pyrridonyl, and carbonyl, alcohol and carboxylic acid derivatives thereof having one to twenty five atoms, and hydroxyl, amino, amide, carboxyl, ester, carbonyl, sulfhydryl, sulfonyl, phosphoral, bromo, iodo, chloro and fluoro derivatives; the silane is covalently linked to the nitrogen and the vacant valence of the silane is to a further A or B or terminal hydrogen or hydroxyl group or alkyl, alkene or alkyne or trace co-reactants; as used above, B represents 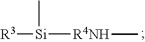
wherein R³ and R⁴ each independently represent hydrogen, alkyl, alkenyl, alkynyl, aromatic, amino alkyl, amino alkenyl, amino alkynyl, pyridinyl, pyrridonyl, and carbonyl, alcohol and carboxylic acid derivatives thereof having one to twenty five atoms, and hydroxyl, amino, amide, carboxyl, ester, carbonyl, sulfhydryl, sulfonyl, phosphoral, bromo, iodo, chloro and fluoro derivatives; the silane is covalently linked to the nitrogen and the vacant valence of the silane is to a further A or B or terminal hydrogen or hydroxyl group or alkyl, alkene, or alkyne, W or trace co-reactants wherein W is represented by the formula —R⁸—Si—R⁸ₐ⁻R⁷_{b}; R⁶ is as defined with respect to R¹ or R²; R⁷ is hydrogen C₁-C₆ straight, cyclic or branched alkyl group; R⁸ is Cl, Br, I, C₁-C₅ alkoxy, dialkylamino or trifluoromethanesulfonate; a and b are each an integer from 0 to 3 provided that a+b=3; and, R⁸ is alkyl or hydrogen; and, X and Y represent relative amounts of A or B as decimals that together add to 1.0.

6. The device of claim 1 wherein said polysilazane or polysilazane-like material has a formula set forth below:

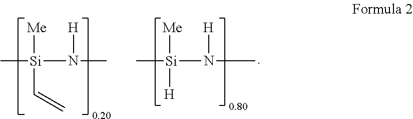

7. A method of making a device for performing liquid chromatography having at least one wetted surface, said method comprising the step of making such device or a layer comprising said wetted surface of a composition of a polysilazane or a polysilazane-like material.

8. The method of claim 7 wherein said wetted surface is part of at least one of the group selected from components, channel devices, conduits, flow cells, valves, pumps, supports, microfluidic devices, columns, column fittings and frits.

9. The method of claim 7 wherein said polysilazane or polysilazane-like material has the formula set forth below:
-[A]ₓ-[B]_{y}- Formula 1;
as used above, A represents 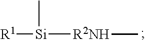
wherein R¹ and R² each independently represent hydrogen, alkyl, alkenyl, alkynyl, aromatic, amino alkyl, amino alkenyl, amino alkynyl, pyridinyl, pyrridonyl, and carbonyl, alcohol and carboxylic acid derivatives thereof having one to twenty five atoms, and hydroxyl, amino, amide, carboxyl, ester, carbonyl, sulfhydryl, sulfonyl, phosphoral, bromo, iodo, chloro and fluoro derivatives; the silane is covalently linked to the nitrogen and the vacant valence of the silane is to a further A or B or terminal hydrogen or hydroxyl group or alkyl, alkene or alkyne or trace co-reactants; as used above, B represents 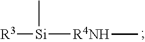
wherein R³ and R⁴ each independently represent hydrogen, alkyl, alkenyl, alkynyl, aromatic, amino alkyl, amino alkenyl, amino alkynyl, pyridinyl, pyrridonyl, and carbonyl, alcohol and carboxylic acid derivatives thereof having one to twenty five atoms, and hydroxyl, amino, amide, carboxyl, ester, carbonyl, sulfhydryl, sulfonyl, phosphoral, bromo, iodo, chloro and fluoro derivatives; the silane is covalently linked to the nitrogen and the vacant valence of the silane is to a further A or B or terminal hydrogen or hydroxyl group or alkyl, alkene or alkyne, or W, or trace co-reactants wherein W is represented by the formula —R⁶—Si—R⁸ₐ^{-R}⁷_{b}; R⁶ is as defined with respect to R¹ or R²; R⁷ is hydrogen C₁-C₆ straight, cyclic or branched alkyl group; R⁸ is Cl, Br, I, C₁-C₅ alkoxy, dialkylamino or trifluoromethanesulfonate; a and b are each an integer from 0 to 3 provided that a+b=3; and, R⁸ is alkyl or hydrogen; and, X and Y represent relative amounts of A or B as decimals that together add to 1.0.

10. The method of claim 7 wherein said polysilazane has a formula set forth below: [chemical structure]
